(19) United States
(12) Patent Application Publication
(10) Pub. No.: US 2023/0304648 A1
(43) Pub. Date: Sep. 28, 2023

(54) Ceiling Light Bulb Socket Decorative Cover

(71) Applicant: Cristhian Zacarias Cespedes, Winter Park, FL (US)

(72) Inventor: Cristhian Zacarias Cespedes, Winter Park, FL (US)

(21) Appl. No.: 18/102,286

(22) Filed: Jan. 27, 2023

Related U.S. Application Data
(60) Provisional application No. 63/322,734, filed on Mar. 23, 2022.

(51) Int. Cl. F21V 17/06; F21V 17/00

(52) U.S. Cl. CPC F21V 17/06; F21V 17/002

(57) ABSTRACT

A decorative cover for a single-lightbulb ceiling socket that can improve the appearance of preinstalled ceiling sockets without need of removing them and replacing them with other fixtures has a dome-shaped main body made of a heat resistant material, having an outer circumference, a convex inner bowl of the approximate size and depth of a regular ceiling lightbulb socket a concave outer bump between the inner bowl and the outer circumference; and a central hole of the adequate diameter to insert an adapter in it (for example 26 mm). A male/female adapter which has a Bottom Thread, a Top, a body, and a Top Thread can be included together with the cover (attached to it or built into it) or provided separately in the package.

### CROSS-REFERENCE TO RELATED APPLICATION

This application claims the benefit of U.S. Provisional Patent Application No. 63/322,734, filed Mar. 23, 2022, which is incorporated by reference herein in its entirety.

### TECHNICAL FIELD

This invention relates generally to the field of ceiling lighting fixtures. More particularly, the present invention relates to a decorative cover for a single-lightbulb ceiling socket.

### BACKGROUND OF THE INVENTION

In a time in which esthetics, style and design play a key role in the industry of lighting fixtures, single-lightbulb ceiling sockets (hereinafter “sockets”) are still widely popular in environments in which affordability is a priority. Some examples of commercially available sockets include Leviton white outer box lamp holder, Leviton plastic keyless lamp holder, Eaton porcelain keyless ceiling socket and Walmart's Hyper tough white base porcelain lamp holder TD 350786. These sockets, and others of similar shape and general design, are some of the cheapest and most practical ways of having a lightbulb functionally installed to the ceiling. They usually offer a ceiling mount made of porcelain or plastic that can be easily screwed into the ceiling, with a retail price starting around a dollar or two. For this reason, this kind of sockets can be seen in multiple installations like homes, offices, schools, factories, and many others.

In case someone wants to upgrade the appearance of these sockets to something more elegant or decorative, the current options require the need of uninstalling the existing sockets and installing a new lighting fixture instead of them. Besides expensive, this option likely requires hiring someone to do the job, implying more expenditure in labor, especially when the number of sockets to be replaced is significantly large. Replacing these sockets by other lighting fixtures is a waste also because a number of perfectly good and working sockets would have to be discarded or repurposed, just for the reason of appearance.

A fixture that allows a user to improve the aesthetic appearance of a single-lightbulb ceiling socket by covering it with a more aesthetic material and design in such a simple way that any user can install it without need to hire an expert and without needing any hardware or tools for installation would be an advancement to the field.

There are some existing products that attempt to fulfill this function in suboptimal ways. For example Ohlectric OL-39155 clip-on lampshade, sold on Amazon, is designed to attach to lamps with an A shape, by means of a clip. While this device is placed outside of the lamp, covering it, needing for this reason to be transparent or translucent to let some of the light out, there are no fixtures which are attached to the socket itself instead of the lightbulb, therefore being susceptible of attachment irrespectively of the shape of the lightbulb, and which leave the lightbulb uncovered, outside of the fixture, fully visible without decreasing the level of luminosity, only covering the socket and attached to it by an adapter that intermediates between the existent socket and the lightbulb.

On the other hand, there are lightbulbs like Commercial Electric 7 in. Color Changing White Integrated LED Flushmount Ceiling Light Lampholder Bulb Replacement Fixture, also sold on Amazon specially designed to fit into existing sockets of the kind referred to in this specification and cover them. However, these are lightbulbs and not an accent piece susceptible of being used with existing lightbulbs in existing sockets just by inserting it between the socket and the lightbulb by means of an adapter.

Thus, there is a need for an affordable decorative cover for single-lightbulb ceiling sockets that can be easily installed without needing any tools or hardware. A decorative cover of these characteristics, specifically designed to be attached to the socket by screwing it, into the socket and then screwing the lightbulb into the cover by means of a male/female adapter attached to it, would constitute a cost-effective and practical solution to the need of improving the appearance of preinstalled ceiling sockets without need of replacing them, therefore advancing the field.

### SUMMARY OF THE INVENTION

The main object of the present invention is to provide decorative cover for single-lightbulb ceiling sockets that can improve the appearance of preinstalled ceiling sockets without need of removing them and replacing them with other fixtures.

Another object of the present invention is to provide a decorative cover for single-lightbulb ceiling sockets that can be easily installed without needing any tools or hardware.

Yet another object of the present invention is to provide it in an affordable way that makes it suitable for mass-installations.

A Ceiling Light Bulb Socket Decorative Cover created in accordance with the present invention is achieved by combining some or all of the following aspects:
a) A dome-shaped main body made of a heat resistant material, having:
   1) An outer circumference of 8 to 15 inches of diameter;
   2) A convex inner bowl of the approximate size and depth of a regular ceiling lightbulb socket (approx. 5-6 inches in diameter x 2-3 inches in depth);
   3) A concave outer bump between the inner bowl and the outer circumference; and
   4) A central hole of the adequate diameter to insert an adapter in it (for example 26 mm)
b) A male/female adapter having a Bottom Thread a Top, a body, and a Top Thread. This adapter can be included together with the cover (attached to it or built into it) or provided separately in the package. Alternatively, in some embodiments one of general use can be independently acquired and used.

Furthermore, Ceiling Light Bulb Socket Decorative Cover created in accordance with the present invention offers additional advantages when compared to the prior art, these advantages including but not limited to: a) being designed is such a way that it covers the light bulb socket completely thus providing a more aesthetic appearance to both the ceiling of a room and to the light bulb itself; b) being made of plastic resistant to temperatures between 100c and 250c produced by some bulbs and the heat of the ceiling produced by the sun and high temperatures in the summer and in hot places; c) having in its center a 26 mm male/female adapter on both sides—diameter of the threads a common bulb—also resistant to temperatures between 100c and 250c; and d) providing an easy tool-free way of installation, just by unscrewing the lightbulb from the socket, screwing the top thread of the adapter to the socket, and then screwing the light bulb into the bottom thread of the adapter.

### BRIEF DESCRIPTION OF THE DRAWINGS

FIG. 1A is a perspective view of an embodiment of an Adapter in accordance with the present invention.

FIG. 1B is a front view of an embodiment of an Adapter in accordance with the present invention.

FIG. 1C is a top view of an embodiment of an Adapter in accordance with the present invention.

FIG. 1D is a bottom view of an embodiment of an Adapter in accordance with the present invention.

FIG. 2 is an exploded view of an embodiment of an Adapter in accordance with the present invention.

FIG. 3A is a front view of an embodiment of a Ceiling Light Bulb Socket Decorative Cover in accordance with the present invention shown together with a Ceiling Light Bulb Socket to which it will be attached.

FIG. 3B is a side view of an embodiment of a Ceiling Light Bulb Socket Decorative Cover in accordance with the present invention shown together with a Ceiling Light Bulb Socket to which it will be attached.

FIG. 3C is a back view of an embodiment of a Ceiling Light Bulb Socket Decorative Cover in accordance with the present invention shown together with a Ceiling Light Bulb Socket to which it will be attached.

FIG. 4A is a front perspective view of an embodiment of a Ceiling Light Bulb Socket Decorative Cover in accordance with the present invention, without the adapter.

FIG. 4B is a back perspective view of an embodiment of a Ceiling Light Bulb Socket Decorative Cover in accordance with the present invention, without the adapter.

FIG. 5A is a front perspective view of an embodiment of a Ceiling Light Bulb Socket Decorative Cover in accordance with the present invention, with the adapter.

FIG. 5B is a back perspective view of an embodiment of a Ceiling Light Bulb Socket Decorative Cover in accordance with the present invention, with the adapter.

FIG. 6 is a front perspective exploded view of an embodiment of a Ceiling Light Bulb Socket Decorative Cover in accordance with the present invention, with the adapter and a lightbulb.

FIG. 7 is a back perspective exploded view of an embodiment of a Ceiling Light Bulb Socket Decorative Cover in accordance with the present invention, with the adapter and a lightbulb.

FIG. 8 is a back perspective assembled view of an embodiment of a Ceiling Light Bulb Socket Decorative Cover in accordance with the present invention, with the adapter and a lightbulb.

### DETAILED DESCRIPTION AND BEST MODE OF IMPLEMENTATION

Disclosed is an Ergonomic height-adjustable erotic furniture and methods for the use of such piece of furniture for facilitating sexual intercourse in different positions.

Some general aspects of the present invention have been summarized so far in the previous sections of this disclosure. Hereinafter, a detailed description of the invention as illustrated in the drawings will be provided. While some aspects of the invention will be described in connection with these drawings, it is to be understood that the disclosed embodiments are merely illustrative of the invention, which may be embodied in various forms. The specific materials, methods, structures, and functional details disclosed herein are not to be interpreted as limiting. Instead, the intended function of this disclosure is to exemplify some of the ways—including the presently preferred ways—in which the invention, as defined by the claims, can be enabled for a Person of Ordinary Skill in the Art. Therefore, the intent of the present disclosure is to cover all variations encompassed within the spirit and scope of the invention as defined by the appended claims, and any reasonable equivalents thereof.

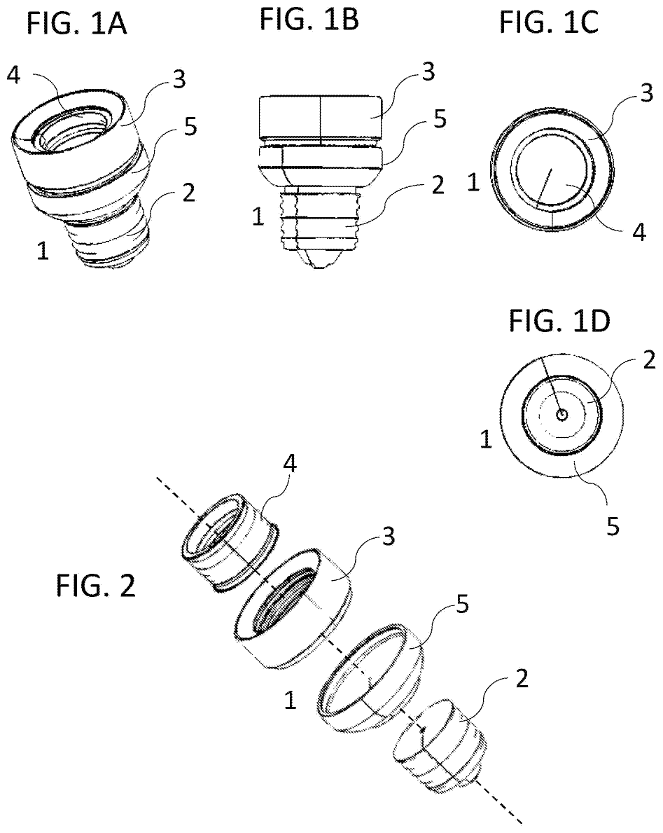

Referring to the drawings in more detail, FIG. 1 illustrates an embodiment of an Ergonomic height-adjustable erotic furniture having a board 1, which is the base for supporting bodies of the users of this invention. This board 1, is the top part of the Divan, and has a length adequate for the size of a human body to be reclined on it, as well as for its decorative and practical location in a room, similar to the size of a regular two-body sofa, long-chaise, or divan. An adequate length for this part would be 180 cm, but it can vary according to design, being a reasonable length anywhere between the measures of 160 cm and 200 cm. Ideal materials for this board 1 are high quality foams, having a thickness from 10 to 15 cm, and covered in upholstery which can be in various suitable materials like Polyurethane, PVC vinyl leather or even authentic leather or other natural or synthetic materials. The board 1 is supported by an Extensible Base 2, which rests over a support plate 3, with the adequate shape size and materials to support the structure of the furniture. In some embodiments, this support plate 3 is anchored to the floor. The furniture also has a header 4 rising from the board 1 and made from the same materials than this board. This element can be built into the board as a single piece or can be attached to it, having the function of providing comfort such as backrest and headboard. As it will be shown, this header 4 takes important functionalities when it comes to sexual positions. In some embodiments, this header 4 can have an ergonomic comfortable shape as shown in the drawings, with a variable height of 40 to 50 cm additional to the thickness of the board 1. The width in the top part of this header 4, in the shown embodiment, is of approximately 68 cm, being this width, in general, a few centimeters less than the width at the base of this header 4. The board 1 has a variable width due to having curved edges. These curved edges include a Right Concave Edge 5, a left concave Edge 6 and a Front Convex Edge 7, meant for providing a comfortable support for a variety of sexual positions, while delivering a pleasant and discreet aesthetic appearance. The curvature of these edges shouldn't be too accentuated, nor to shallow, representing a difference of 10% to 40% between the thinner and the wider widths of the board 1.

In FIG. 2, shown from the top, the curvature of these Right Concave Edge 5, left concave Edge 6 and Front Convex Edge 7 can be best appreciated. The specific shape of the header 4, the board 1 and the support plate 3 are for illustrative purposes only and can vary, in other embodiments, according to design, as long as the spirit and scope of the present invention is maintained.

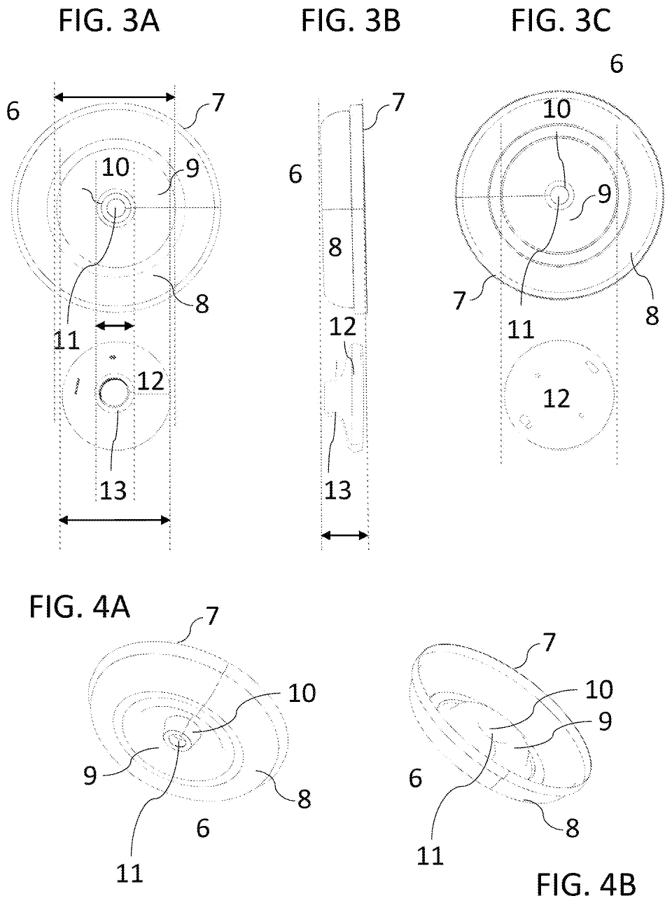

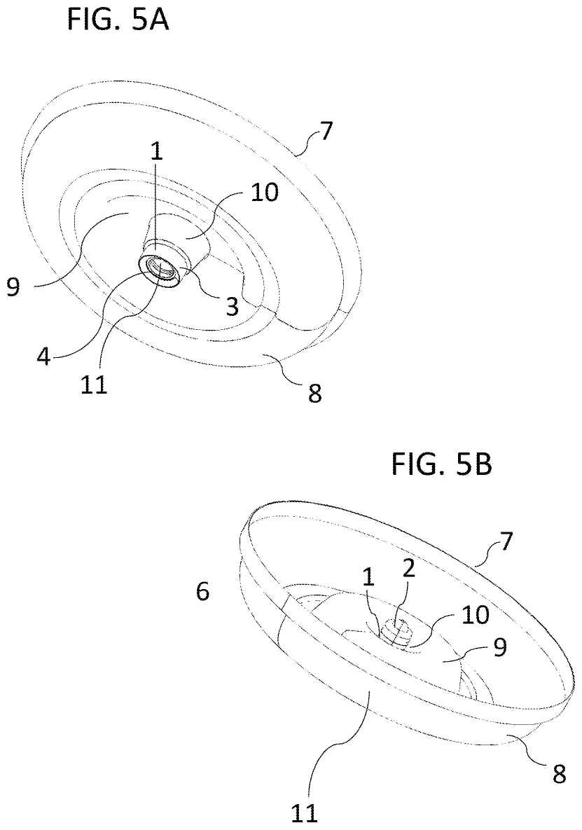

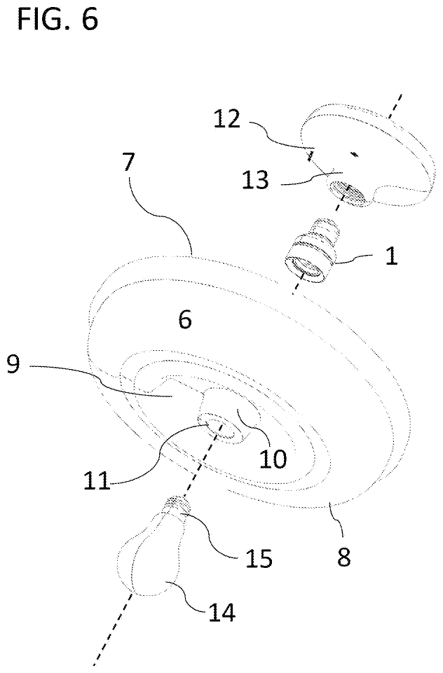

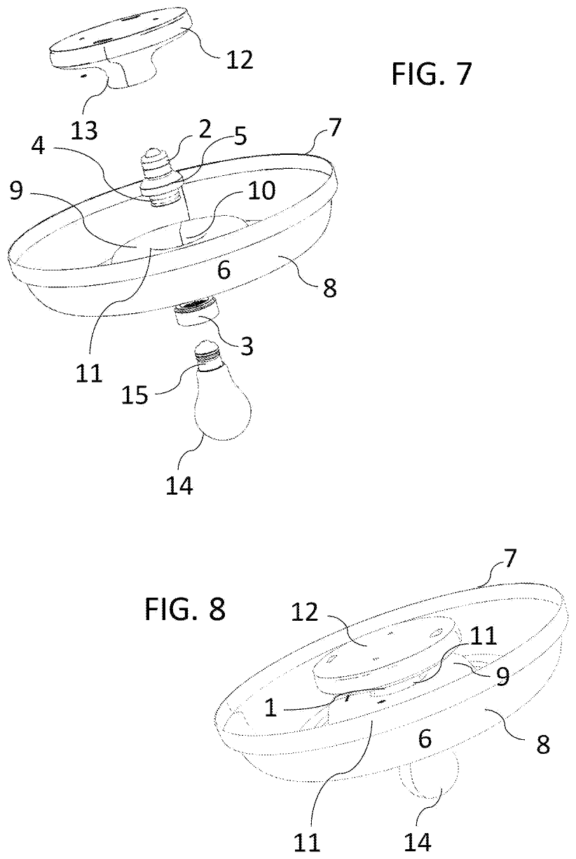

FIG. 3 shows the divan in its high position. In this embodiment this is achieved by having two telescopic parts, the Extensible Base inner telescopic part 2a and the Extensible Base outer telescopic part 2b. This is just one of the many ways in which—through a lift mechanism—the board can move from a lower position 8 of around 32 cm (plus the thickness of the board 1) to a higher position 9 of around 89 cm (plus the thickness of the board 1), as shown in FIGS. 4 and 5 from the front and in FIGS. 6 and 7 from the side. Different embodiments of this invention include different lifting mechanisms such as electrical, mechanical, hydraulic, pneumatic and/or mixed, known and/or to be developed, different aesthetic means of covering such mechanisms, for example accordion-like, flexible materials, more telescopic parts, etc., and different ways of activating these mechanisms (remote control, buttons, physical switches or levers, digital touchscreen, Bluetooth, etc.).

Lastly, FIG. 8 shows different positions in which an embodiment of an Ergonomic height-adjustable erotic furniture in accordance with the present invention can be used for facilitating sexual intercourse. In the position 10, for example, it can be seen how, in a low position of the furniture, its header 4 is useful for supporting the woman's pelvis in an adequate height for adjusting it to the man's height for effortless penetration with the man standing. It is important that the furniture can acquire many different heights between the lower position 8 and the higher position 9 so to adapt to the precise height and needs of the users. In the position 11, shown in a high position of the furniture, the woman is sitting in the feet area of the board 1, near the Front Convex Edge 7 and the man is standing facing her at the appropriate height for comfortable intercourse in this position. Similarly, position 12 also locates the woman near the Front Convex Edge 7 with the man is standing facing her at the appropriate height for comfortable intercourse in a slightly different position, in which the legs of the woman are wide open. Positions 13, 15, 16 and 18 distinctly show the importance of the Right Concave Edge 5 and the left concave Edge 6 for the comfort of some important sexual positions, given that they facilitate the support of the man's weight at the adequate height with one foot (positions 13 and 15), or two feet (positions 16 and 18, in which the woman's height is taken into account when fixing the adequate height for the board 1, since she is the one baring the weight here). On the other hand, positions 14 and 17 demonstrate how the furniture can also be used for facilitating comfortable oral sex thanks to effortlessly aligning the pelvis of one user with the face of the other one. These are just some illustrations out of a virtually infinite variety of sexual positions that can be promoted and facilitated with this discrete piece of furniture thanks to its height adjustment and ergonomic features.

The description as set forth is not intended to be exhaustive or to limit the invention to the precise form disclosed. Many modifications and variations are possible in light of the teachings above without departing from the spirit and scope of the forthcoming claims.

1. A decorative cover for a single-lightbulb ceiling socket comprising:
a) a dome-shaped main body made of a heat resistant material, having:
1) an outer circumference of 8 to 15 inches of diameter;
2) a convex inner bowl of the approximate size and depth of a regular ceiling lightbulb socket;
3) a concave outer bump between the inner bowl and the outer circumference; and
4) a central hole of the adequate diameter to insert an adapter in it; and
b) a male/female adapter, attachable to the cover, having a bottom thread and a top thread;
wherein the main body is designed to cover the light bulb socket completely; and
wherein the main body is made of plastic resistant to temperatures between 100c and 250c.
